(19) United States
(12) Patent Application Publication
(10) Pub. No.: US 2005/0275141 A1
(43) Pub. Date: Dec. 15, 2005

(54) Method of making multi-component molded plastic articles with plasma treatment of pre-injection molded parts

(75) Inventor: Christoph Lange, Altomunster (DE)

Correspondence Address: HENRY M FEIEREISEN, LLC, 350 FIFTH AVENUE, SUITE 4714, NEW YORK, NY, 10118, US

(73) Assignee: KRAUSS-MAFFEI KUNSTSTOFFTECHNIK GMBH, Munchen (DE)

(21) Appl. No.: 11/206,392

(22) Filed: Aug. 18, 2005

Related U.S. Application Data
(63) Continuation of application No. PCT/EP04/00534, filed on Jan. 23, 2004.

(30) Foreign Application Priority Data
Feb. 28, 2003 (DE) 103 08 742.7

(51) Int. Cl. B29C 45/06; H05H 1/26

(52) U.S. Cl. 264/478; 264/255; 264/483; 264/328.8

(57) ABSTRACT

In a method for producing a multi-component molded plastic article from a first thermoplastic component and a second component made of a cross-linking elastomer, the thermoplastic component, after being produced, is subjected to a plasma gas stream in a predetermined bonding zone, and the elastomer component is only then molded onto the thermoplastic component.

### CROSS-REFERENCES TO RELATED APPLICATIONS

This application is a continuation of prior filed copending PCT International application no. PCT/EP2004/000534, filed Jan. 23, 2004, which designated the United States and on which priority is claimed under 35 U.S.C. §120, and which claims the priority of German Patent Application, Serial No. 103 08 742.7, filed Feb. 28, 2003, pursuant to 35 U.S.C. 119(a)-(d), the subject matter of which is/are incorporated herein by reference.

### BACKGROUND OF THE INVENTION

The present invention relates to a method of making a multi-component molded plastic article from a first thermoplastic component and a second component of a cross-linking elastomer.

Nothing in the following discussion of the state of the art is to be construed as an admission of prior art.

Japanese publication JP 11-320609 describes the production of multi-component injection-molded articles that are each made of a thermoplastic material. In order to increase the bonding force between the individual thermoplastic components, the injection-molded thermoplastic component is subjected to a plasma gas stream before molding a subsequent thermoplastic component thereon. Described by way of example is the production of a two-component molded part having as first component a rigid thermoplastic component and as second component a thermoplastic elastomer such as TPE for example. Once the molded part has been produced from the rigid thermoplastic component in the first molding step, the injection mold is opened for introduction of a plasma spraying device between the half-molds to subject the molded part of rigid thermoplastic component to a plasma gas stream. After conclusion of the plasma treatment, the plasma spraying device is withdrawn from the opened injection mold, the half-molds are rotated, and in the next step a thermoplastic elastomer as second component is molded onto the pre-treated molded part in the one mold, while in the other mold another molded part of rigid thermoplastic component is produced.

Production of multi-component injection molded plastic articles made of a thermoplastic material and a cross-linking elastomer has proven more difficult. Both types of plastics are so different from one another that both plastics cannot be bonded or bonded only insufficiently during the multi-component injection molding process. To address this problem, various approaches are known which involve a mechanical anchoring of the elastomer in undercuts of the thermoplastic component. (WO 00/23241, U.S. Pat. No. 5,246,065, U.S. Pat. No. 5,160,474). The presence of such undercuts is disadvantageous because of the restriction imposed in connection with dimensioning the configuration of the molded part and furthermore the unnecessary complication and thus cost-intensive construction of the injection molds.

German Offenlegungsschrift DE 195 40 333 C2 discloses a method which involves the production of a rigid thermoplastic component in a first injection-molding step, and then a corona treatment is carried out in the bonding region of the rigid thermoplastic component. The soft component which may be a cross-linking elastomer such as, e.g., silicone rubber is molded on only in the subsequent injection-molding step. By treating the connection zones using corona discharge, a permanent bonding between such different plastics types could be realized for the first time. A drawback of corona treatment is the direct conduction of the corona onto the first molded part, i.e. the corona flashes impact the surface and leave spots. As a result, the first component is treated comparably unevenly, accompanied by a locally high thermal stress. Moreover, corona treatment is difficult to control, as the “flashes” search for their target by themselves.

It would therefore be desirable and advantageous to provide an improved method of making a multi-component molded plastic article from a first thermoplastic component and a second component of a cross-linking elastomer to obviate prior art shortcomings and to realize a uniformly good bond of the thermoplastic component with the cross-linking elastomer while exposing the thermoplastic component to little stress and yet being easier to control.

### SUMMARY OF THE INVENTION

According to one aspect of the present invention, a method of making a multi-component molded plastic article comprised of a thermoplastic component and a cross-linking elastomer component, comprising the steps of (a) injection-molding in a cavity of an injection mold a thermoplastic component to produce a pre-injection-molded part, (b) subjecting the pre-injection-molded part to a plasma gas stream in a predefined bonding zone, and (c) injection-molding a cross-linking elastomer to the pre-injection-molded part at least in the bonding zone.

According to another aspect of the present invention, a method of making a multi-component molded plastic article comprised of a thermoplastic component and a cross-linking elastomer component, comprising the steps of (a) injection-molding in a cavity of an injection mold a cross-linking elastomer component to produce a pre-injection-molded part of a cross-linked elastomer, (b) subjecting the pre-injection-molded part to a plasma gas stream in a predefined bonding zone, and (c) injection-molding a thermoplastic component to the pre-injection-molded part at least in the bonding zone.

The present invention resolves prior art problems by surprisingly recognizing that a permanent bond between a thermoplastic component and a cross-linking elastomer is possible, even when the thermoplastic component is exposed to a plasma gas stream instead of undergoing a corona treatment which is difficult to control. Superior bonding results can be attained in the absence of any environmentally harmful bonding agents.

The thermoplastic component is typically injected in a cooled mold, whereas the cavity needs to be heated for the cross-linking elastomer in order to implement cross-linkage. The thermoplastic component may involve, i.a., PC, PA, PST, PP and others. LSR (Liquid Silicone Rubber) finds wide application as cross-linking elastomer. However, also HNBR, NBR, ACM, EPDM, FPM and similarly cross-linking elastomers may be used depending on the respective field of application.

According to another feature of the present invention, the subjecting step may be executed inside the injection mold.

According to another feature of the present invention, the subjecting step may be executed immediately after step (a).

According to another feature of the present invention, the method may include the further step of transferring the pre-injection-molded part to another cavity of the injection mold after the subjecting step and before carrying out the step (c). Suitably, the transferring step is implemented by a turntable of the injection mold for turning the pre-injection-molded part to the other cavity.

According to another feature of the present invention, the method may include the further step of transferring the pre-injection-molded part to another cavity of the injection mold after the subjecting step, and subjecting the plasma-treated pre-injection-molded part to a plasma gas stream before carrying out the step (c).

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a plan view of a rotary injection mold in opened state,

FIG. 2 shows a cross section of the injection mold in opened state,

FIG. 3 shows a sectional view of a plasma nozzle.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

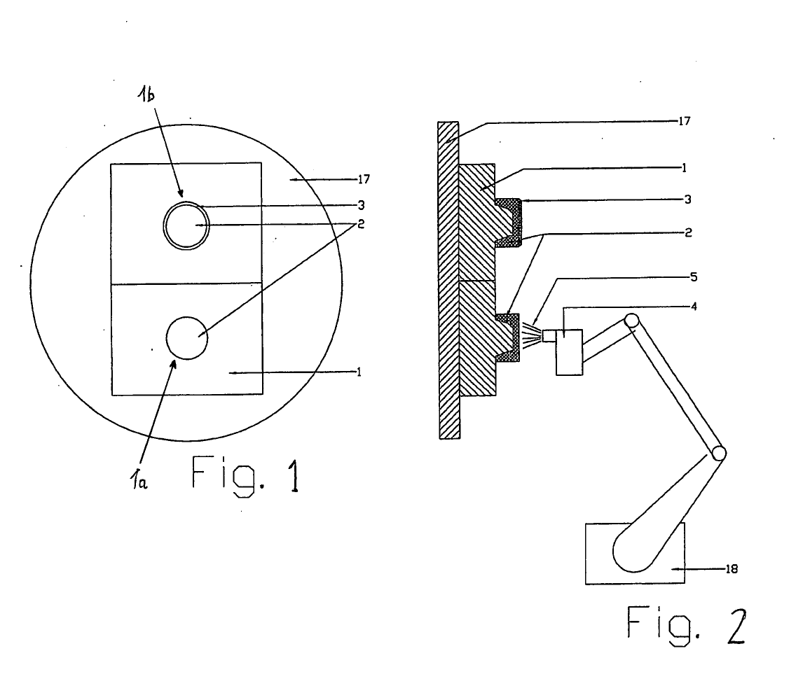

Turning now to the drawing, and in particular to FIGS. 1 and 2, there is shown a rotary injection mold having a lower half-mold 1 mounted onto a turntable 17 and defining with an unillustrated upper half-mold two different cavities 1a, 1b. The cavity 1a of the injection mold is used here for producing a pre-injection molded part 2 of a rigid thermoplastic component in a first molding stage. After opening the injection mold, a plasma nozzle 4 is moved by means of a suitable handling device 18 over the pre-injection molded part 2 which is then exposed to a plasma gas stream 5. The turntable 17 and thus the lower half-mold 1 is thereafter rotated and closed again. In a second cycle, the second component of the cross-linking elastomer can be molded onto the pre-injection molded part 2 in the cavity 1b. Any structure may basically be used as pre-injection molded part for attachment of an elastomer.

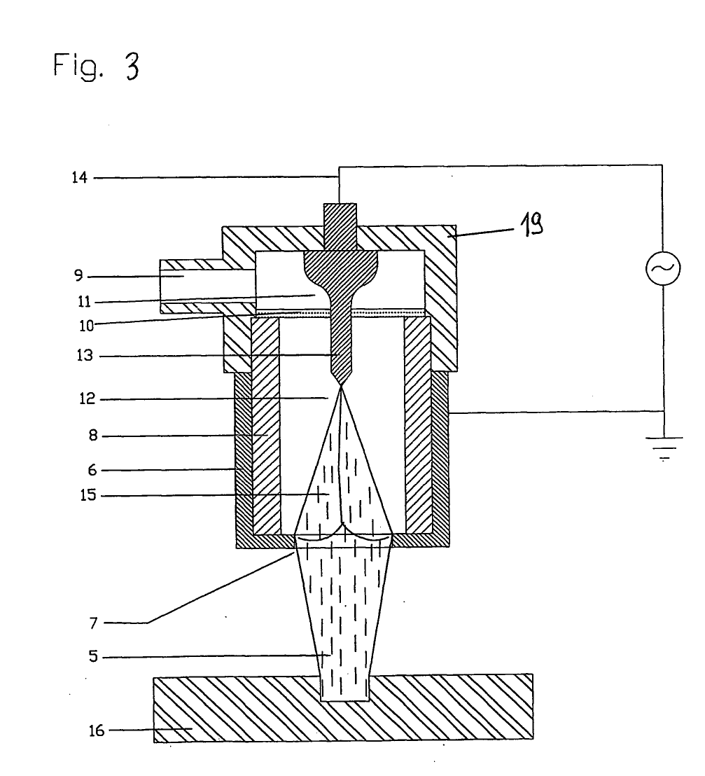

As can be seen from FIG. 3, a suitable plasma nozzle 4 has a housing 6 of special steel with a nozzle head 7 and an insulating layer 8 on the inner wall of the housing 6. A gas line 9 terminates in a lid 19 of the plasma nozzle 4 and is connected to a gas supply station which is not shown here. An apertured plate 10 separates the interior of the housing 6 into a gas supply space 11 and a gas discharge space 12. Mounted to the apertured plate 10 is a first electrode 13 which is connected via a line 14 to a high-voltage source which is not shown here. The nozzle head 7 of the special steel housing 6 acts as second electrode which is grounded. When switched on, plasma 15 is ignited between the electrode 13 ad the nozzle head 7 and exits the nozzle in the form of a plasma gas stream 5 to impact the surface 16 of the pre-injection-molded part 2. The plasma gas stream 5 enables an even and comparably gentle treatment of the pre-injection molded parts.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

1. A method of making a multi-component molded plastic article comprised of a thermoplastic component and a cross-linking elastomer component, comprising the steps of:
(a) injection-molding in a cavity of an injection mold a thermoplastic component to produce a pre-injection-molded part;
(b) subjecting the pre-injection-molded part to a plasma gas stream in a predefined bonding zone; and
(c) injection-molding a cross-linking elastomer to the pre-injection-molded part at least in the bonding zone.

2. The method of claim 1, wherein the cross-linking elastomer is selected from the group consisting of LSR, HNBR, NBR, ACM, EPDM and FPM.

3. The method of claim 1, wherein the thermoplastic component is selected from the group consisting of PC, PA, PBT and PP.

4. The method of claim 1, wherein the subjecting step is executed inside the injection mold.

5. The method of claim 1, wherein the subjecting step is executed immediately after step (a).

6. The method of claim 1, wherein the subjecting step is executed after step (a), and further comprising the step of transferring the pre-injection-molded part to another cavity of the injection mold after the subjecting step and before carrying out the step (c).

7. The method of claim 6, wherein the transferring step is implemented by a turntable of the injection mold for turning the pre-injection-molded part to the other cavity.

8. The method of claim 1, wherein the subjecting step is executed after step (a), and further comprising the steps of transferring the pre-injection-molded part to another cavity of the injection mold after the subjecting step, and subjecting the plasma-treated pre-injection-molded part to a plasma gas stream before carrying out the step (c).

9. The method of claim 8, wherein the transferring step is implemented by a turntable of the injection mold for turning the pre-injection-molded part to the other cavity.

10. A method of making a multi-component molded plastic article comprised of a thermoplastic component and a cross-linking elastomer component, comprising the steps of:
(a) injection-molding in a cavity of an injection mold a cross-linking elastomer component to produce a pre-injection-molded part of a cross-linked elastomer;
(b) subjecting the pre-injection-molded part to a plasma gas stream in a predefined bonding zone; and
(c) injection-molding a thermoplastic component to the pre-injection-molded part at least in the bonding zone.

11. The method of claim 10, wherein the cross-linking elastomer is selected from the group consisting of LSR, HNBR, NBR, ACM, EPDM and FPM.

12. The method of claim 10, wherein the thermoplastic component is selected from the group consisting of PC, PA, PBT and PP.

13. The method of claim 10, wherein the subjecting step is executed inside the injection mold.

14. The method of claim 10, wherein the subjecting step is executed immediately after step (a).

15. The method of claim 10, wherein the subjecting step is executed after step (a), and further comprising the step of transferring the pre-injection-molded part to another cavity of the injection mold after the subjecting step and before carrying out the step (c).

16. The method of claim 15, wherein the transferring step is implemented by a turntable of the injection mold for turning the pre-injection-molded part to the other cavity.

17. The method of claim 10, wherein the subjecting step is executed after step (a), and further comprising the steps of transferring the pre-injection-molded part to another cavity of the injection mold after the subjecting step, and subjecting the plasma-treated pre-injection-molded part to a plasma gas stream before carrying out the step (c).

18. The method of claim 17, wherein the transferring step is implemented by a turntable of the injection mold for turning the pre-injection-molded part to the other cavity.
